(19) United States
(12) Patent Application Publication
(10) Pub. No.: US 2019/0339081 A1
(43) Pub. Date: Nov. 7, 2019

(54) UNMANNED AERIAL VEHICLE WITH ENCLOSED PROPULSION SYSTEM FOR 3-D DATA GATHERING AND PROCESSING

(71) Applicant: Orby, Inc., Mountain View, CA (US)

(72) Inventor: Shrey Malhotra, Mountain View, CA (US)

(21) Appl. No.: 16/403,129

(22) Filed: May 3, 2019

Related U.S. Application Data
(60) Provisional application No. 62/666,613, filed on May 3, 2018.

(51) Int. Cl. G01C 21/20; G05D 1/10; G05D 1/00; B64D 47/08; B64D 47/02; B64F 1/36; B64C 39/02; B64C 27/00; B64D 45/00

(52) U.S. Cl. CPC G01C 21/206; G05D 1/106; G05D 1/0094; B64D 47/08; B64D 47/02; G01S 17/933; B64C 39/024; B64C 27/001; B64D 45/00; B64C 2201/027; B64C 2201/123; B64F 1/362

(57) ABSTRACT

Embodiments are described for an unmanned aerial vehicle (UAV) including a shell structure and air ducts enclosing a propeller propulsion system. Additionally, sensors gathered by the UAV are analyzed for use in autonomous flight. Finally, the data gathered by the UAV are further analyzed by a distributed computing or cloud system for generating a detailed three-dimensional representation of the environment in which the UAV operates.

### CROSS-REFERENCE TO RELATED APPLICATIONS

This application claims priority to U.S. Provisional Patent Application Serial No. 62/666,613, filed on May 3, 2018, the entire contents of which are hereby incorporated by reference.

### TECHNICAL FIELD

Embodiments of the invention relate to a novel and safer unmanned aerial vehicle (UAV) that can be operated indoors and in close proximity to people by reducing the risk and harm of crashing. Moreover, the invention relates to a UAV with an enclosed rotary propulsion system that reduces the dangers of injury to individuals or damage to the UAV.

Embodiments of the invention also relate to an integrated system architecture to collect data from one or more UAVs. The data is transmitted to various edge-computing devices and to the cloud. This data is analyzed to generate a virtual reality or augmented reality representation of the environment mapped by the UAVs.

### TECHNICAL BACKGROUND

Currently, UAVs and drones are primarily used for outdoor flights due to their size, design, and the availability of a positioning system, such as the global positioning system (GPS). On the other hand, UAVs and drones are dangerous and difficult to operate indoors in GPS-denied spaces or in close proximity to people. Specifically, concerns about indoor navigation and safety from injury to individuals and damage to the UAVs are factors that have prevented UAVs from prevalent indoor use.

However, recently such aerial devices and systems have become useful for collecting data and performing repeatable and/or automated tasks. The indoor application of UAVs can help various industries collect data and provide better insight into their facilities and operations.

A quadcopter or a drone is an unmanned aerial vehicle that uses propellers for its propulsion and control. A propeller consists of two or more blades that are attached to a high-speed motor that help the propellers generate sufficient lift for flight. One pair of motors spin opposite to another pair of motors to keep the angular momentum constant (zero in this case) so that the drone or UAV does not spin on its axis. These propellers spin at a high RPM (rotations per minute) and can cause serious harm or damage if they collide with a person or other objects. Currently, operating an UAV or drone indoors is only possible in a research-controlled environment or a large open space that is closely supervised. It is difficult for current UAVs and drones to navigate safely in tight spaces, such as homes, retail stores, small warehouses, malls, underground tunnels, pipelines, construction, buildings, and more.

Additionally, due to rapid development of smaller sensors and powerful onboard GPU (graphical processing units), better algorithms are being be deployed to allow such UAVs and drones to avoid obstacles, navigate, and localize. However, these algorithms are not effective at all times and still lead to collisions and accidents.

UAVs and drones are used in applications, such as aerial photography, outdoor asset management, etc. These UAVs and drones carry a plurality of aerial sensors, such as visual sensors or infrared cameras. These sensors collect a large amount of data during flight. The operator retrieves the data after each flight for analysis. This data can include, for example, video feeds, sensor values, flight information, and statistics. This data helps the operator to analyze and make decisions offline. However, such bigger and unsafe UAVs and drones cannot be used indoors even though similar demand exists for such indoor use.

Therefore, a need exists to build safer, collision tolerant UAVs and drones that can be operated autonomously (or manually) indoors and around people. Furthermore, a need exists for these UAVs to operate in indoor locations for applications such as emergency response mapping, indoor asset management, inventory management, and more.

### BRIEF DESCRIPTION OF DRAWINGS

One or more embodiments of the present disclosure are illustrated by way of example and not limitation in the figures of the accompanying drawings, in which like references indicate similar elements. These drawings are not necessarily drawn to scale.

FIG. 1 is a schematic two-point perspective view of an example UAV, according to one or more embodiments of the present disclosure.

FIG. 2 is a schematic side view of the example UAV, according to one or more embodiments of the present disclosure.

FIG. 3 is a schematic bottom view of the example UAV, according to one or more embodiments of the present disclosure.

FIG. 4 is a schematic top view of the example UAV, according to one or more embodiments of the present disclosure.

FIG. 5 is a schematic two-point perspective view of the bottom portion of the example UAV, according to one or more embodiments of the present disclosure.

FIG. 6 is a schematic two-point perspective view of the example UAV and docking station, according to one or more embodiments of the present disclosure.

FIG. 7 is a schematic top view of an example system for operating the example UAV, according to one or more embodiments of the present disclosure.

FIG. 8 is a diagram of the example system for operating the example UAV, according to one or more embodiments of the present disclosure.

FIG. 9 is a block diagram illustrating an example of a processing system in which at least some operations described herein can be implemented.

FIG. 10 is a flow diagram illustrating an example process for environmental data gathering and processing, according to one or more embodiments of the present disclosure.

### DETAILED DESCRIPTION

Certain embodiments of the present disclosure will be described in detail below in reference to the related technical solutions and accompanying drawings. In the following description, numerous specific details are set forth to provide a thorough understanding of the presently disclosed technology. In other embodiments, the techniques described here can be practiced without these specific details. In other instances, well-known features, such as specific fabrication techniques, are not described in detail in order to avoid unnecessarily obscuring the present technology. References in this description to “an embodiment,” “one embodiment,” or the like mean that a particular feature, structure, material, or characteristic being described is included in at least one embodiment of the present disclosure. Thus, the instances of such phrases in this specification do not necessarily all refer to the same embodiment. On the other hand, such references are not necessarily mutually exclusive. Furthermore, the particular features, structures, materials, or characteristics can be combined in any suitable manner in one or more embodiments. Also, it is to be understood that the various embodiments shown in the figures are merely illustrative representations and are not necessarily drawn to scale.

Embodiments of the invention provide a safe design that prevents the propellers and the components from colliding with obstacles and humans. This allows safe navigation around people indoors and in confined spaces. Embodiments of the invention provide an UAV with propellers inside an enclosed aerodynamic shell made from lightweight materials such as, but not limited to, Styrofoam, carbon fiber, and plastic.

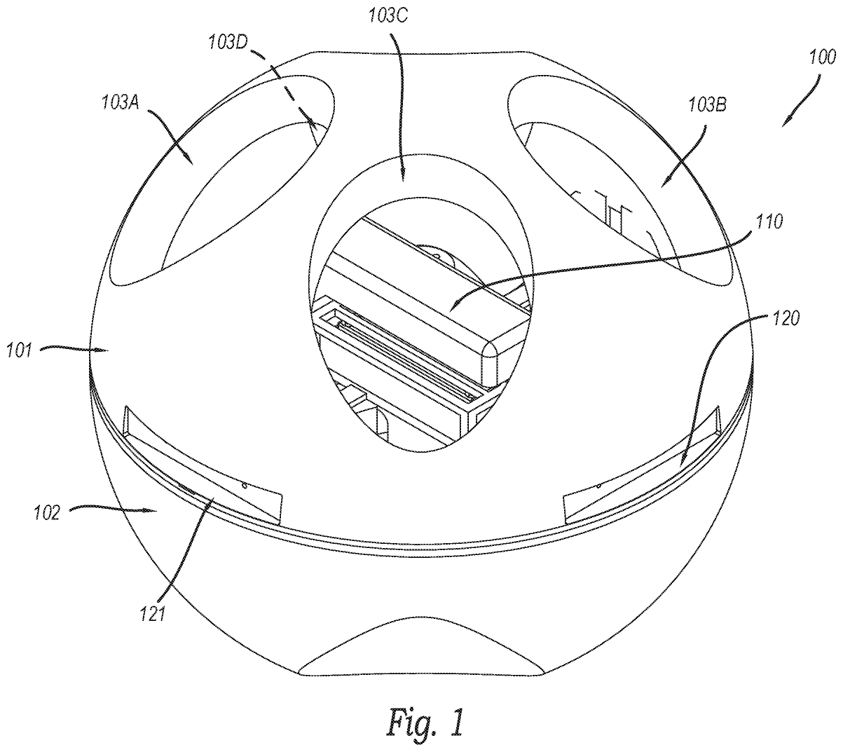

FIG. 1 is a schematic two-point perspective view of an example UAV 100, according to one or more embodiments of the present disclosure. The perspective view shows a top shell portion 101, bottom shell portion 102, air ducts 103A-D, battery 110, front sensors 120, and side sensors 121.

Top shell portion 101 and bottom shell portion 102 may be joined to form a light weight shell structure designed for aerodynamic efficiency that enables UAV 100 to operate indoors while providing protection against collisions. For example, the shell structure shields internal components of UAV 100 such as batteries, sensors, processors, propellers, etc. from damage caused by the impact of a collision. Additionally, the shell structure is light weight so that a propulsion system may achieve lift, carry cargo, and execute flight controls without excessive power demands. In some embodiments, the shell structure is a three-dimensional spherical or elliptical shape such that sharp corners and edges are minimized to improve aerodynamic efficacy.

Top shell portion 101 and bottom shell portion 102, when joined, may form air ducts 103A-D for directing airflow generated by the propellers. For example, air ducts 103A-D may be each form a vertical tube that directs airflow generated by propellers downward for UAV 100 to achieve lift. Additionally, the vertical tubes may shield the airflow from air disturbances that may reduce the efficiency of the propulsion system. In some embodiments, the tube may extend below the overall shape of bottom shell 102 to further direct air exhaust and reduce propeller wash. In yet other examples, the vertical tubes may isolate noise caused by operation of the propellers. Taken together, air ducts 103A-D may form tubes that direct airflow, increase propulsion efficiency, reduce propeller wash, and isolate noise. These desirable characteristics allow UAV 100 to more easily operate indoors by reducing the risk of injury, reducing the risk of damage to UAV 100, improving the performance of UAV 100, and minimizing the disturbance caused by noise and propeller wash.

Battery 110 may be used to store energy used to operate UAV 100. For example, battery 110 may provide energy to a propulsion system to allow UAV 100 to operate in the air, sensors to gather environment data, and processors to navigate UAV 100 and transmit gathered data to remote receivers. In some embodiments, battery 110 may be a lithium-ion battery, wherein the capacity may range from 3,000 to 5,000 mAh. In other embodiments, battery 110 may be a fuel cell, fuel used to operate combustion engines, or any other means to store energy for controlled use by UAV 100.

Front sensors 120 and side sensors 121 are used to gather data about the environment in which UAV 100 operates. The gathered data may be used to navigate UAV 100 within the environment by allowing collision avoidance and collision recovery operations. Additionally, the gathered data may be combined and analyzed to generate a detailed virtual representation of the environment for emergency response mapping, indoor asset management, inventory management, and more. Front sensors 120 and side sensors 121 may include one or more of: light detection and ranging (LIDAR) sensors, infrared depth cameras, stereo cameras, RGB cameras, high definition visual cameras, inertial measurement unit (IMU) devices, position beacon receivers, global positioning system (GPS) receivers, thermal cameras, barcode scanners, pressure sensors, radiation sensors, air quality sensors, noise level detectors, RFID sensors, and motion detectors.

In some embodiments, front sensors 120 include a front stereo camera. The stereo camera uses two or more lenses to allow UAV 100 to capture 3-D images. Additionally, or alternatively, front sensors 120 may include an RGB camera for capturing visual data and a depth camera for determining a distance corresponding to the captured visual data. Using this data, UAV 100 may detect obstacles near the front of it and determine an alternative clear path forward. Similarly, side sensors 121 may include an infrared depth camera and RGB camera. Here, side sensors 121 captures data that can be used for obstacle avoidance as well as data collection for analysis. For example, image analysis may be used to generate a detailed virtual representation of the environment in which UAV 100 operates. The virtual representation of the environment may be used to for emergency response mapping, indoor asset management, inventory management, and more.

In some embodiments, front sensors 120 and side sensors 121 are configured to perform simultaneous localization and mapping (SLAM) computations to gather information regarding the environment in which UAV 100 operates. SLAM computations are aimed at generating a map of the environment and estimating the location of UAV 100 relative to the generated map. In some embodiments, UAV 100 uses the infrared depth camera to project voxels onto the corresponding points of captured by the RGB camera. The projected voxels form point clouds that approximate the location and position of potential obstacles detected by UAV 100 into a 3-D map.

By navigating according to the 3-D map, UAV 100 can perform autonomous flight operations including obstacle avoidance and/or collision recovery operations. For example, a person in the flight path of UAV 100 will appear as a point cloud comprising voxels that are positioned based upon the distance measurement of the infrared depth camera and the visual image of the RGB camera. Once the UAV 100 sees the point cloud, it may execute flight controls to stop, slow down, or plot another flight path to avoid the point cloud.

As will be described in further detail herein, UAV 100 may contain various components to facilitate flight control, cargo capacity, navigation functionality, and data collection. For example, UAV 100 may have an onboard computer system that may include one or more real time processing units (PRUs), multiple I2C (Inter-Integrated Circuit) ports to connect to peripheral sensors and cameras, UARTs and DSP (Digital Signal Processing) units for high efficiency computer vision processing. The CPU (Central Processing Unit) may offload computationally expensive processing to the DSP and/or co-processor. The onboard unit therefore, may also include a power management unit and a heatsink to reduce the heat. Among the various embodiments, UAV 100 may include one or more stereo cameras to calculate depth and distance from obstacles. These cameras are calibrated, and the data is sent over to the edge devices. The depth data may also be calculated using Time-of-Flight (ToF) sensors. This data is used by the edge computing devices to build a map and localize UAV 100.

In some embodiments, UAV 100 may carry cargo or components for additional functionality. For example, UAV 100 may include a display device that enables UAV 100 to showcase videos, photos, and other interactive applications. The display device on UAV 100 can be controlled from base stations or the GUI application of any device communicatively coupled to UAV 100. The display can be used to provide information about the tasks or the goals of the UAVs in order to notify any nearby person of its intentions for safety purposes. Additionally, UAV 100 may include an audio system that allows UAV 100 to playback audio streams, music, and other voice signals. The audio system is also be used to notify and warn people about the presence of the UAV. Battery may power the display and audio system 110 and receive data from flight controller 112 and/or onboard processor 113 for output.

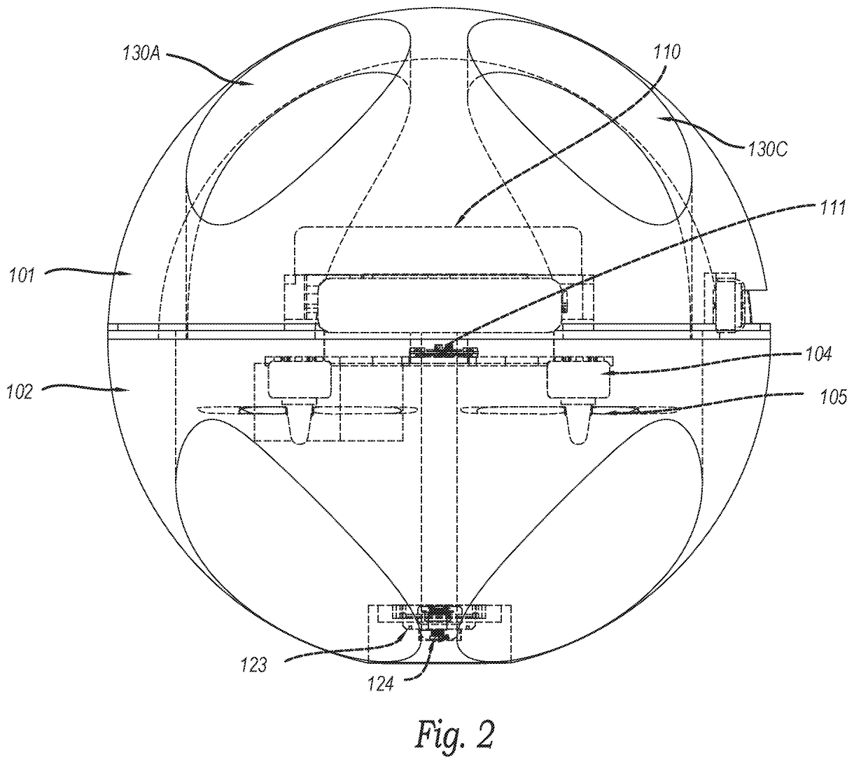

FIG. 2 is a schematic side view of UAV 100, according to one or more embodiments of the present disclosure. In addition to the elements described in FIG. 1, FIG. 2 depicts a power distribution board (PDB) and electronic speed control system (ESC) 111, motors 104, propellers 105, height sensor 123, and downward camera 124. The PDB portion of power distribution board (PDB) and electronic speed control system (ESC) 111 is used to distribute power from battery 110 to the various components of UAV 100. The ESC component of power distribution board (PDB) and electronic speed control system (ESC) 111 is an electric circuit that controls motors 104. By controlling the speed of motors 104, the rate of lift and other flight controls may be regulated to allow UAV 100 to maneuver in the air.

Motors 104 are high speed motors that cause propellers 105 to rotate and generate enough lift for the flight. In some embodiments, one pair of motors spin opposite to another pair of motors to keep the angular momentum constant such that UAV 100 does not spin on its axis. Propellers 105 typically spin at a high RPM (rotations per minute) to achieve enough lift. In some embodiments, motors 104 may spin at a rate of 2000 to 4000 RPM based upon the performance demands, availability of power, etc.

Additionally, by changing the speed of the motors, it is possible to hover, pitch, yaw, and roll. A flight controller uses data from onboard IMU, barometer, magnetometer, a gyroscope, and other sensors to determine the appropriate flight maneuvers to execute for navigation, obstacle avoidance, and collision recovery. Because motors 104 typically spin fast, contact with another object may cause severe injury or damage. Additionally, the high speed of motors 104 and propellers 105 generates significant noise and propeller wash. Finally, motors 104 draw significant power in order to rotate propellers 105 fast enough to achieve lift, carry cargo, and execute flight controls. As such, it is important to reduce air disturbance to increase the efficiency of the motor operation. Therefore, the shell structure of top shell portion 101 and bottom shell portion 102 provides protection from collision, noise, and air disturbance.

Height sensor 123 is a downward aiming sensor used to generate height data representing the height of the UAV 100. In some embodiments, the height sensor 123 may be implemented as a 1-D laser rangefinder or LIDAR. Bottom camera 124 is a downward aiming sensor to generate movement data representing the motion of UAV 100 along a horizontal plane. In some embodiments, bottom camera 124 may be an optical flow sensor that gathers a stream of images and analyzes changes in each image to generate movement data. The movement data represents the movement of UAV 100 along a horizontal X-Y plane. Therefore, UAV 100 may use the movement data to detect unintended drift and execute flight controls to compensate. Additionally, height data and movement data are crucial for navigation, landing, taking off, collision avoidance, and calibration of the data collected.

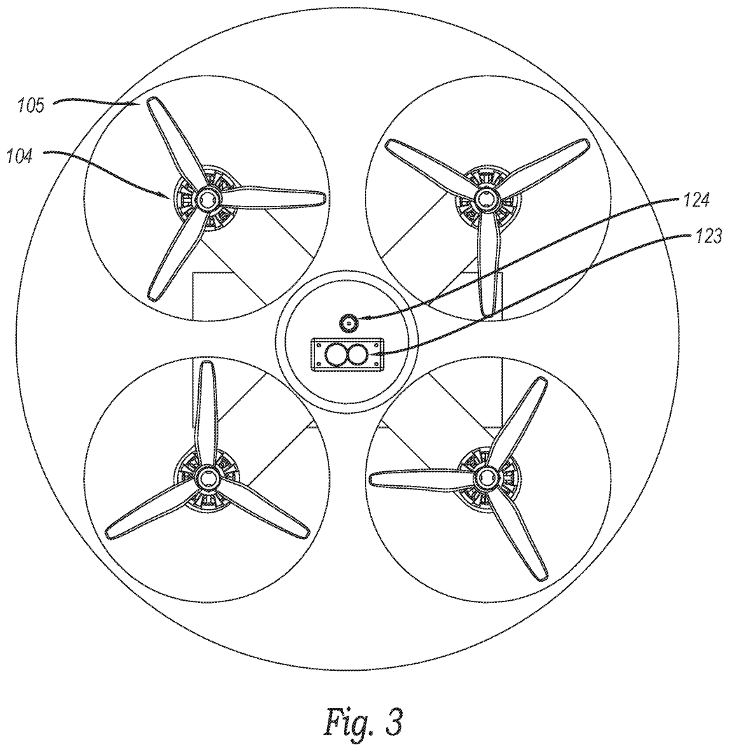

FIG. 3 is a schematic bottom view of the example UAV 100, according to one or more embodiments of the present disclosure. In some embodiments as depicted in FIG. 3, UAV 100 is a quadcopter that uses a set of four propellers 105 for its propulsion and control. Each of propellers 105 are attached to high speed motors 104 that help propeller 105 generate enough lift for flight and to carry cargo. In some embodiments, propellers 105 may have a length of 3 to 4 inches. In larger embodiments, propellers 105 may have a length of 12 inches. Some embodiments of propellers 105 may have three blades. In yet other embodiments, propellers 105 may have a flat blade with a pointed end. Additionally, the blades may tilt at a 30 to 70-degree angle.

However, those skilled in the art will recognize that other configurations of the number of propellers, the length of the blades, number of blades, and the geometry of the blades may be used based upon performance, cost, or other factors. The diameter of air ducts 103A-D are generally determined by the length of propellers 105. In some embodiments, air ducts 103A-D have a diameter that leaves less than one-inch clearance between the tip of the blade and the walls of air ducts 103A-D. Additionally, as shown in FIG. 3, height sensor 123 and bottom camera 124 may be mounted at the center and lowest part of UAV 100. This will allow the sensors to get an accurate and unobstructed sensor reading of the height and movement of UAV 100.

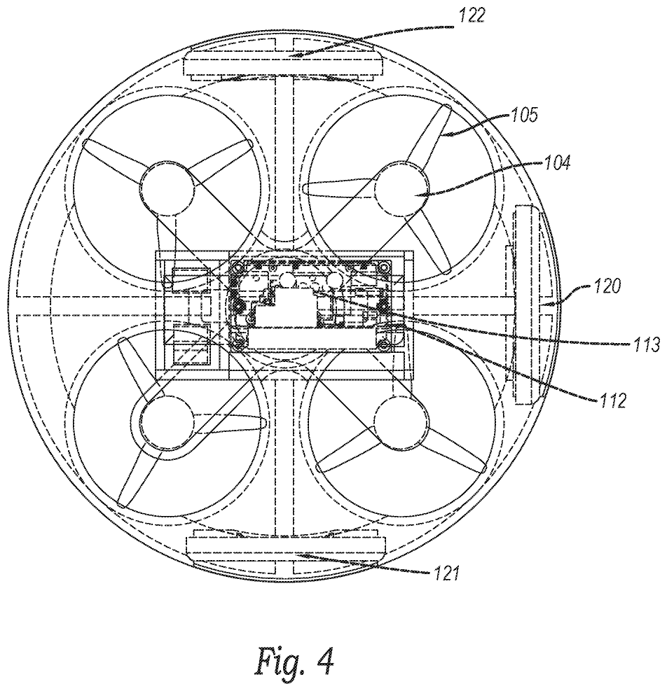

FIG. 4 is a schematic top view of the example UAV 100, according to one or more embodiments of the present disclosure. In addition to the elements described in the previous figures, FIG. 4 depicts a flight control board 112 and/or an onboard CPU/GPU processor 113. Flight control board 112 is responsible for receiving sensor data indicating flight conditions and transmitting control signals to execute flight controls.

In some embodiments, the flight controller board 122 receives power from battery 110 via a power distribution board (PDB) and transmits flight control commands to an electronic speed control system (ESC) associated with motors 104. For example, the flight controller may be embedded with a real-time operating system (RtOS) that is responsible for handling the flight mechanism. By changing the speed of the motors, it is possible to hover, pitch, yaw, and roll. The flight controller uses data from onboard IMU, barometer, magnetometer, a gyroscope, and other sensors. Additionally, all of the data captured by the sensors of UAV 100 may be combined using sensor fusion. The combination of data allows for calibration, comprehensiveness, and redundancy to ensure the gathered data is accurate and useful.

Onboard CPU/GPU processor 113 is a lightweight companion computer/embedded system that is mounted on UAV 100. This is a credit card sized computer (e.g., including a CPU and GPU) executing algorithms for obstacle avoidance, drops in data communication during operation, collision recovery as well as overriding controls from the base station. Onboard CPU/GPU processor 113 is also responsible for streaming sensor data. In some embodiments, processor 113 is used as a fallback and logging processor in case the UAV or drone loses communication with a base station.

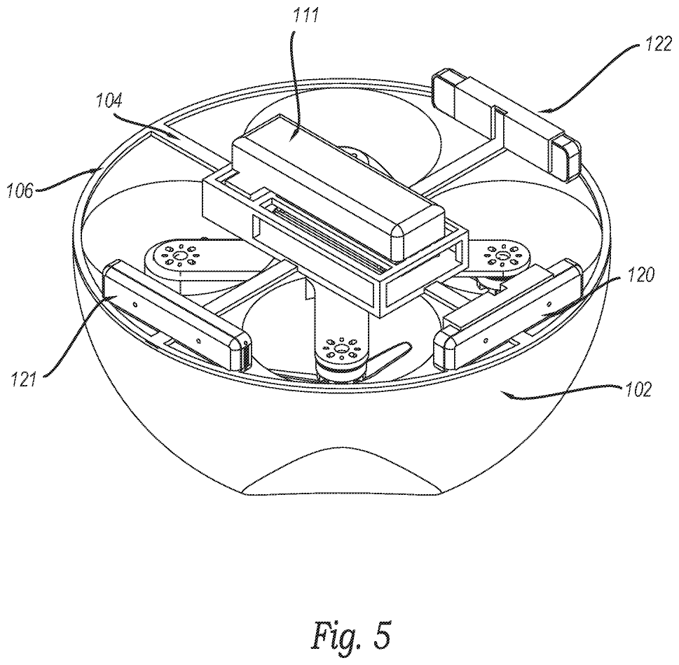

FIG. 5 is a schematic two-point perspective view of the bottom portion of the example UAV 100, according to one or more embodiments of the present disclosure. In addition to the elements described in the previous figures, FIG. 5 depicts an internal frame 104 used to mount the various components of UAV 100. Internal frame 104 is affixed to a ring 106 on the outer edge of UAV 100. Top shell portion 101 and bottom shell portion 102 may be secured onto ring 106 to form the shell structure. In some embodiments, top shell portion 101 and bottom shell portion 102 are designed to be user-removeable to allow on-site users to easily remove, repair, or replace each portion, as necessary. In some embodiments, the top shell portion 101 and bottom shell portion 102 may be secured to ring 106 using a clamp, clasp, hook, or other securing mechanism.

In some embodiments, ring 106 may include a power port for receiving electrical power from an external power source. For example, battery 110 of UAV 100 may receive and store power from a charging station or docking station. In some embodiments, the power port of ring 106 may include conductive material used to transfer electrical power from the external power source to battery 110 via a power distribution board (PDB).

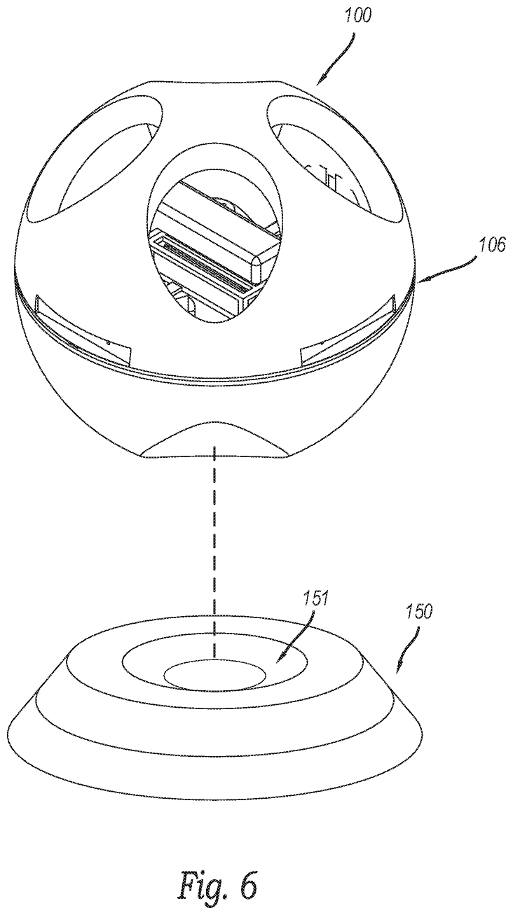

FIG. 6 is a schematic two-point perspective view of the bottom portion of the example UAV, according to one or more embodiments of the present disclosure. In addition to the elements described in the previous figures, FIG. 6 depicts a docking station 150 with a docking station power port 151. Docking station 150 provides a physical landing space for UAV 100 to land. In some embodiments, docking station 150 has a contour that conforms to the shell structure of UAV 100. For example, docking station 150 may have a concave contour to conform with a spherical shape of bottom shell portion 102. Such a shape allows UAV 100 to rest at a fixed location.

Docking station 150 may include a docking station power port 151 that is used to transfer power to UAV 100. In some embodiments, a docking station power port 151 includes conductive material used to transfer electrical power from docking station 150 to UAV 100. When UAV 100 lands on docking station 150, ring 106 of UAV 100 comes into contact with docking station power port 151. The contact between docking station power port 151 and the power port of ring 106 facilitates conduction for transferring electrical power to UAV 100 and specifically to battery 110. Docking station 150 and UAV 100 may each have a corresponding ground port to provide polarity for electricity to flow. In other embodiments, docking station 150 may transfer power to UAV 100 by implementing coils for inductive charging. Additionally, docking station 150 may have a storage for storing energy or may transfer energy from an external source such as an electrical outlet connected to an electrical grid.

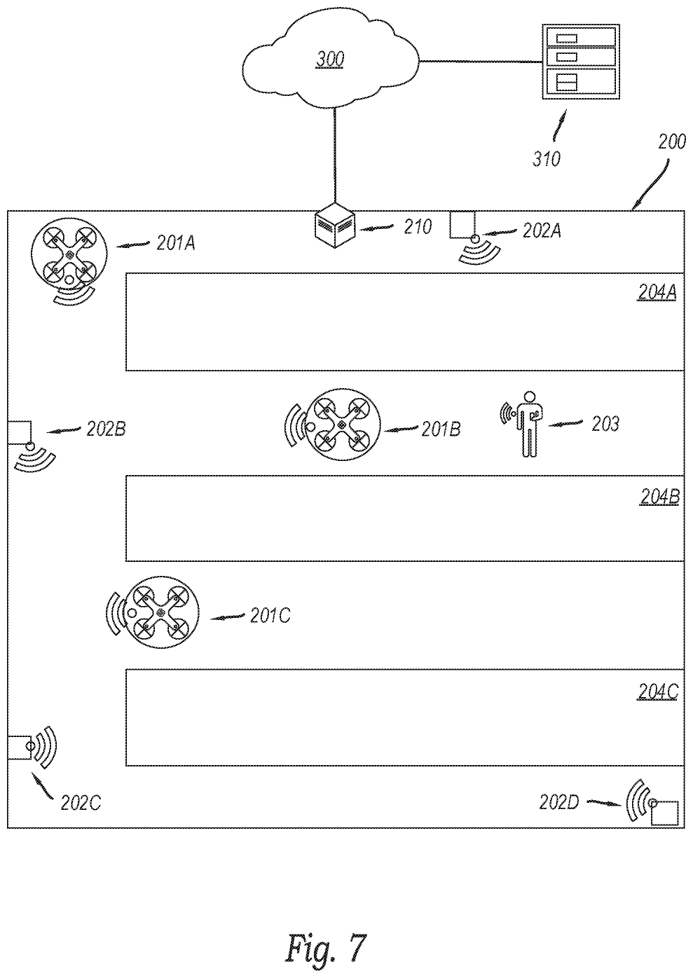

FIG. 7 is a schematic top view of an example system architecture for operating the example UAV, according to one or more embodiments of the present disclosure. The system includes an onsite premise 200, the onsite premise 200 communicatively connected to a cloud resource(s) 310 via data network 300. Onsite premise 200 includes UAVs 201A-C, base stations 202A-D, onsite person 203, obstacles 204A-C, and data router 210.

The system may leverage distributed computing or edge computing architecture to capture, gather, and process flight data from UAVs. For example, UAVs may be responsible for capturing and transmitting flight information and sensor data. However, the bulk of the computation for gathering and processing the data is performed on the base stations 202A-D and/or cloud resource(s) 310.

UAVs 201A-C may each be implemented in a manner consistent with UAV 100. UAVs 201A-C are configured to navigate a flight environment autonomously by collecting flight data to perform obstacle avoidance and/or collision recovery. For example, as shown in FIG. 7, UAVs 201A-C operates within the constraints of an indoor environment including onsite person 203 and obstacles 204A-C.

In some embodiments, base stations 202A-D are primarily responsible for collecting data from UAVs 201A-C and processing it. For example, embodiments of the invention perform computer vision and machine learning algorithms on incoming video feed to detect objects, barcodes, persons of interest, etc. Additionally, embodiments of the invention use telemetry data to record flight path and improve flight controls for subsequent flights. The base station is also responsible for path and trajectory planning, mapping, and task organization. In some embodiments, base stations 202A-D are directly powered from an external power source. In yet other embodiments, base stations 202A-D also be implemented to function as a docking station in a manner consistent with docking station 150.

Base stations 202A-D may consist of a GPU (Graphical Processing Unit) for parallel computing and a large data storage device that records data from flights performed by UAVs 201A-C. Base stations 202A-D may use high speed Wi-Fi and radio link to communicate with UAVs 201A-C. For example, UAVs 201A-C may transmit one or more of: telemetry data, indoor GPS data from beacons, high-definition video stream that can be saved and processed in real-time, flight logs, sensor data, IMU data, odometry data, depth data, and the battery status of UAVs 201A-C.

In some embodiments, base stations 202A-D may be communicatively connected to data network 300 for transferring the data to cloud resource(s) 310. Embodiments of the invention use both relational database for standard data types such as flight logs and task data, as well as non-relational (e.g., networked graph) databases for storing video feeds, snapshots, and other secure flight data. Embodiments of the invention may also use cloud resource(s) 310 to store this data. The data is encrypted on the base station before it is transferred to the cloud over https (SSL).

The data from UAVs 201A-C may be parsed and compiled into flight data that provides information on onsite premise 200. In some embodiments, the flight data includes high resolution images of the flight environment that are captured by the high-resolution video stream. The high-resolution video stream may be transferred to cloud resource(s) 310 for analysis. For example, the high-resolution images are analyzed to recognize objects such as goods, barcodes, persons of interest, etc. The recognized objects may be used for asset management, inventory management, etc.

Cloud resource(s) 310 may perform both data storage and data analysis functions. In some embodiments, flight data from one or more UAVs 201A-C may be combined by base stations 202A-D to generate environment data that provides information regarding onsite premise 200. The data may be stored in a relational database for standard data types such as flight logs and task data, as well as non-relational (e.g., networked graph) databases for storing video feeds, snapshots, and other secure flight data. Some or all of the data is encrypted on the base station before it is transferred to the cloud over https (SSL).

In some embodiments, the Cloud resource(s) 310 is used as an analytics platform to perform data mining and extraction on the large data sets that are collected. For example, the platform allows time-series data to be mapped to a local geo-spatial indoor map. Embodiments of the invention also map the data in 3-D using the data from the depth camera. For example, data from depth cameras and RGB cameras may be combined to generate photorealistic, 3-D representations of onsite premise 200.

In one example, data collected from UAVs 201A-C may be used by retail stores to map their inventory, including but not limited to barcodes, product counts, and product categories to a given physical space. This data can also be used to keep track of an ongoing operation or a project in industries like oil & gas production, aerospace manufacturing, and construction management. In the inspection industry, UAVs 201A-C may help digitize the data which are currently collected manually.

The data collected from UAVs 201A-C and stored on cloud resource(s) 310 may be accessed using a Graphical User Interface (GUI) via a desktop application, mobile application, web-browser, etc. For example, the GUI may display the UAV or drone status and can be used for mission planning and real-time data analysis. The GUI allows the operator of UAVs 201A-C to control flight and data gathering operations. The GUI also provides the operator with an overview of the tasks the UAV or drone is currently working on and a history of previously executed tasks. In some embodiments, commands to UAVs 201A-C sent from remote devices may be overridden by flight controller 112 and onboard processor 113 as they will have a higher command priority.

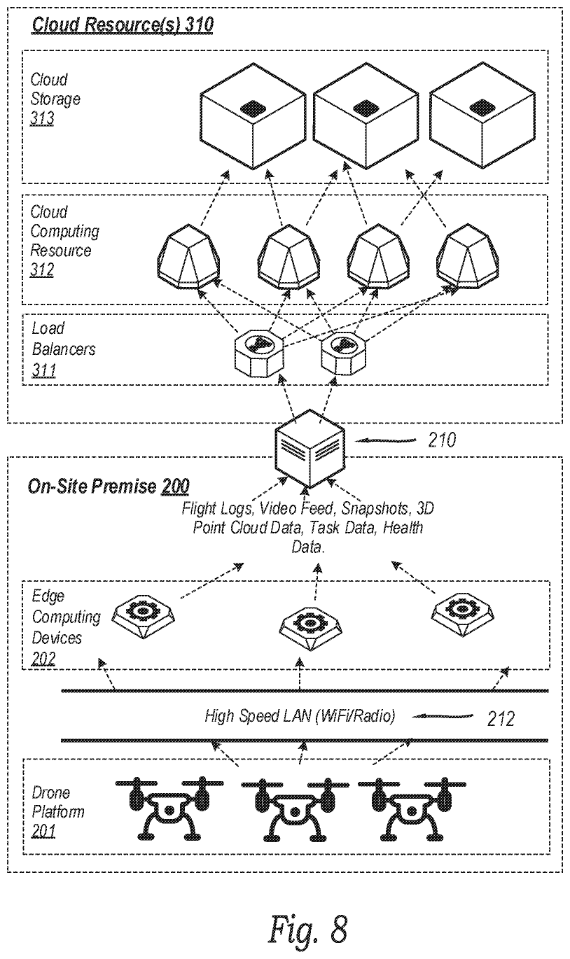

FIG. 8 is a diagram of the example system for operating the example UAV, according to one or more embodiments of the present disclosure. FIG. 8 depicts additional details of the system architecture depicted in FIG. 7. The system architecture is an overview of the distributed computing platform.

In some embodiments, the data is collected from UAV platform 201 and sent to edge computing devices 202. In some embodiments, UAV platform 201 includes UAVs that are implemented in a manner that is consistent with UAV 100 and UAVs 201A-C. Similarly, the edge computing devices 202 may be implemented in a manner that is consistent with base stations 202A-D of FIG. 7. Since UAVs 201A-C collect a high volume of data, a high-speed Wireless LAN or radio link 212 is preferred to transfer the data. Additionally, or alternatively, UAV platform 201 may directly transmit data to edge computing devices 202 without using a high-speed Wireless LAN or radio link 212. Edge computing devices 202 then processes and filters the data before it is transferred to cloud resource(s) 310. As shown in FIG. 8, the data that is processed and filtered may include flight logs, video feeds, snapshots, 3-D point cloud data, task data, health data, etc. Once the data is processed and filtered, data router 210 transmits the data to cloud resource(s) 310. The processed and filtered data may be considered environment data that provides information regarding on-site premise 200. Since the data may contain sensitive information, the data may be shared over a secure connection such as a connection using HTTPS.

Cloud resource(s) 310 may consists of high availability servers or computing devices which are connected with load balancers to divide and manage the data computation and storage load. The servers process the incoming data and store them in a database cluster so that the data is replicated across servers and can be used by the analytics platforms. As shown in FIG. 8, cloud resource(s) 310 may include load balancers 311, cloud computing resources 312, and cloud storage resources 313. Load balancers 311 are responsible for receiving the environment data from data router 210 and distributing the data and computing tasks.

In some embodiments, load balancers 311 may transfer data to cloud computing resource 312 for data analysis and visual data filtering. For example, high resolution images are may be analyzed by computing resource 312 to recognize objects such as goods, barcodes, persons of interest, etc. Additionally, point cloud data may be analyzed and consolidated to generate a dense (i.e., a robust data set with redundancy and consistency) 3-D map of on-site premise 200. The analyzed data may be transferred from cloud computing resource 312 to cloud storage 313.

In other embodiments, load balancers 311 may transfer data to cloud storage 313. As mentioned above, the data is collected from one or more of UAVs 201A-C. In some embodiments, the data may be stored in a hierarchical data format. This data format can be searched and queried quicker since the data is stored and indexed in a well-defined pattern. The data collected is also filtered depending on the application, for instances in an inspection application, the location high resolution snapshots were taken, etc.

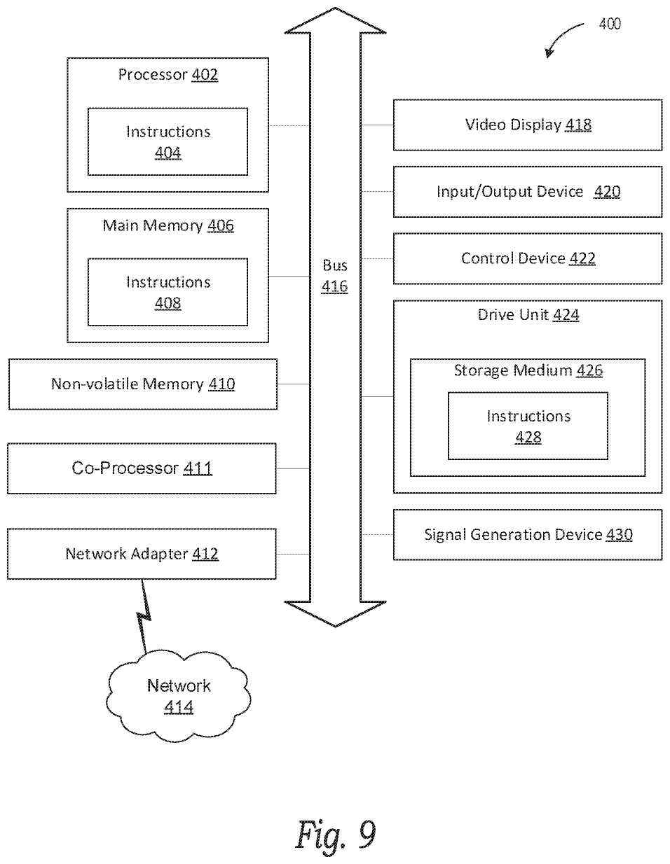

FIG. 9 is a block diagram illustrating an example of a processing system 400 in which at least some operations described herein can be implemented. For example, some components of the processing system 400 may be implemented in UAV 100 and 200A-C, base stations 202A-D, load balancers 311, cloud computing resources 312, and cloud storage resources 313.

The processing system 400 may include one or more central processing units (“processors”) 402, main memory 406, non-volatile memory 410, co-processor 411, network adapter 412 (e.g., network interface), video display 418, input/output devices 420, control device 422 (e.g., keyboard and pointing devices), drive unit 424 including a storage medium 426, and signal generation device 430 that are communicatively connected to a bus 416. The bus 416 is illustrated as an abstraction that represents one or more physical buses and/or point-to-point connections that are connected by appropriate bridges, adapters, or controllers. The bus 416, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”). Co-processor 411 may be configured to perform mathematical operations or real-time tasks such as flight control. Additionally, Co-processor 411 may have a serial bus connection directly with processor 402 to exchange data and commands.

The processing system 400 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 400.

While the main memory 406, non-volatile memory 410, and storage medium 426 (also called a “machine-readable medium”) are shown to be a single medium, the term “machine-readable medium” and “storage medium” should be taken to include a single medium or multiple medium (e.g., a centralized/distributed database and/or associated caches and servers) that store one or more sets of instructions 428. The term “machine-readable medium” and “storage medium” shall also be taken to include any medium that is capable of storing, encoding, or carrying a set of instructions for execution by the processing system 400.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in a computing device. When read and executed by the one or more processors 402, the instruction(s) cause the processing system 400 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 410, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 412 enables the processing system 400 to mediate data in a network 414 with an entity that is external to the processing system 400 through any communication protocol supported by the processing system 400 and the external entity. The network adapter 412 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 412 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications, and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

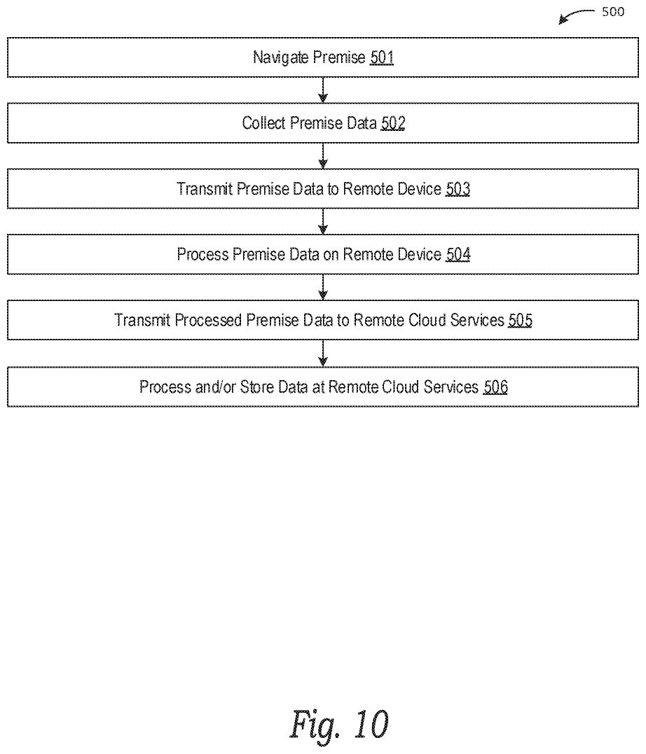

FIG. 10 is a flow diagram illustrating an example process for data gathering and processing. In some embodiments, UAV 201A-C may be configured to navigate premise 200 and collect data regarding premise 200 for data processing, transmission, and storage in a system described in FIGS. 7 and 8.

In step 501, UAV 201A-C may navigate premise 200 to gather data regarding the environment of premise 200 for processing. As described above, UAV 201A-C may gather navigation data as it operates within premise 200. UAV 201A-C may use the navigation data to perform various navigation functions such as obstacle avoidance and collision recovery. In some embodiments, front sensors 120 and side sensors 121 may collect data using front stereo cameras, RGB cameras, depth cameras, etc. to gather information about premise 200. In some examples, the front sensors 120 and side sensors 121 may be used to detect user 203 and obstacles 204A-C. In another example, height sensor 123 and bottom camera 124 may be used to gather data regarding the position of UAV 201A-C. In some embodiments, the various sensors of UAV 201A-C gather data to produce a point cloud map used to avoid obstacles.

In step 502, UAV 201A-C may collect data regarding premise 200 as it navigates within premise 200. The collected data may include navigation data used in step 501 as well as additional data collected by front sensors 120, side sensors 121, height sensor 123 and/or bottom camera 124. For example, the sensors may include a high-resolution camera for capturing high resolution images for processing. The processing may be performed to achieve image recognition, optical character recognition, QR code recognition, barcode recognition, etc. In another example, the sensors may capture information using a barcode scanner to scan barcodes affixed within premise 200. In yet another example, a receiver may be used to gather RFID information from RFID tags.

In step 503, the data collected in step 502 may be transmitted to a remote device. In some embodiments, UAV 201A-C may transmit collected data to base stations 202A-D for processing and forwarding as described in FIGS. 7 and 8. The data may be transmitted wirelessly from UAV 201A-C to base stations 202A-D. For example, the transmissions may use technologies and standards such as IEEE 802.11, 3G cellular networks, 4G cellular networks, 5G cellular networks, Bluetooth technologies, etc. In other embodiments, optical or acoustic transmissions may be used to perform the data transmissions.

In step 504, base stations 202A-D process the data received in step 503 from UAV 201A-C. For example, base stations 202A-D may be configured to perform computer vision and machine learning algorithms on incoming video feed to detect objects, barcodes, persons of interest, etc. Additionally, base stations 202A-D may be configured to parse collected data such as telemetry data, indoor GPS data from beacons, high-definition video stream that can be saved and processed in real-time, flight logs, sensor data, IMU data, odometry data, depth data, and the battery status. In some embodiments, the data for processing and forwarding are received from a plurality of devices such as UAV 201A-C. Therefore, the parsing may include combining and organizing data from multiple sources in a meaningful fashion. For example, the data may be organized based upon the source of the data (e.g., data collected by UAV 201A and the data collected by UAV 201B may be organized separately or grouped together). Additionally, or alternatively, the data may be sorted chronologically or geographically. A person of ordinary skill in the art would recognized that the data may be sorted in various ways for improved storage, indexing, retrieval, etc.

In step 505, the data processed by base stations 202A-D may be transmitted to a remote location. In some embodiments, the data may be transmitted to load balancers 311, cloud computing resources 312, and cloud storage services 313 of cloud resources 310 for processing and storage. The services may be configured to process the incoming data and store them in a database cluster so that the data is replicated across servers and can be used by the analytics platforms. In some embodiments, the data may be transmitted to cloud resources 310 via a wired or wireless data connection. For example, data router 210 may provide premise 200 with a data connection to the data network and cloud resources 310 and transmit the data.

In step 506, the data received at cloud resources 210 may be processed, analyzed, and/or stored. In some embodiments, load balancers 311 may transfer data to cloud computing resource 312 for data analysis and visual data filtering. For example, high resolution images are may be analyzed by computing resource 312 to recognize objects such as goods, barcodes, persons of interest, etc. Additionally, point cloud data may be analyzed and consolidated to generate a dense (i.e., a robust data set with redundancy and consistency) 3-D map of on-site premise 200. The analyzed data may also be transferred from cloud computing resource 312 to cloud storage 313.

In other embodiments, load balancers 311 may transfer data to cloud storage 313. As mentioned above, the data is collected from one or more of UAVs 201A-C. In some embodiments, the data may be stored in a hierarchical data format. This data format can be searched and queried more quickly since the data is stored and indexed in a well-defined pattern. The data collected is also filtered depending on various characteristics of the data (e.g., the location, resolution of the visual data, timestamps, etc. may be used to determine the relevancy of the data). A person of ordinary skill in the art will recognize that the data may be processed and/or stored in a variety of ways to improve the accessibility of the data, improve the analysis of the data, improve the processing and storage efficiency of cloud resources 310, etc.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. An unmanned aerial vehicle (UAV), the UAV comprising:
a propeller propulsion system including one or more motorized propellers for providing lift and flight controls;
a shell structure enclosing the propeller propulsion system and including an air duct for each of the one or more propellers;
a sensor device for collecting flight data, the flight data used to perform analysis of an environment where the UAV operates;
a flight controller configured to transmit control signals to the propeller propulsion system based upon the flight data;
a processor to perform autonomous flight operation of the UAV based upon the flight data and to transmit the flight data to a remote receiver;
a power source to power the operation of the UAV; and
a power port to receive power from an external power source to the power source.

2. The UAV of claim 1, wherein the air duct forms a vertical tube that directs airflow from the one or more propellers and minimize air disturbances that interfere with the airflow.

3. The UAV of claim 2, wherein the vertical tube extends to the bottom of the shell structure to direct airflow exhausted at the bottom of the UAV to reduce propeller wash caused by the one or more propellers.

4. The UAV of claim 1, wherein the shell structure isolates acoustic signals generated by the one or more propellers.

5. The UAV of claim 1, wherein the UAV includes an internal frame used to mount the propeller propulsion system and the shell structure.

6. The UAV of claim 5, wherein the shell structure includes a top shell positioned on the upper side of the UAV, and a bottom shell positioned on the bottom side of the UAV, the top shell and bottom shell coupled to a ring affixed to the internal frame.

7. The UAV of claim 6, wherein the top shell and bottom shell are user-removeable to be separated from the ring.

8. The UAV of claim 6, wherein the power port is mounted on the ring and contains conductive material used to transfer electrical power from the external power source to the power source of the UAV.

9. The UAV of claim 1, further comprising a display mounted on the UAV to output visual data in the vicinity of the UAV.

10. The UAV of claim 1, further comprising an audio output device mounted on the UAV to output audio signals in the vicinity of the UAV.

11. The UAV of claim 1, wherein the sensor device includes one or more of: a light detection and ranging (LIDAR) sensor, an infrared depth camera, an RGB camera, a visual camera, inertial measurement unit (IMU) device, position beacon receivers and global positioning system (GPS) receiver.

12. The UAV of claim 1, wherein the sensor device includes a downward aiming laser used to generate height data representing the height of the UAV.

13. The UAV of claim 1, wherein the sensor device includes a downward aiming optical flow sensor to generate flow data representing the motion of the UAV along a horizontal plane.

14. The UAV of claim 13, wherein the flow data is used by the flight controller to send control signals to the propeller propulsion system to compensate for drift.

15. The UAV of claim 1, wherein the data generated by the various components of the sensor device is combined using sensor fusion.

16. The UAV of claim 11, wherein the RGB camera and infrared depth camera generates environment data used to perform simultaneous localization and mapping (SLAM) computations for autonomous flight operation, the autonomous flight operation including obstacle avoidance and/or collision recovery operations.

17. The UAV of claim 11, wherein the RGB camera and infrared depth camera generates flight data used to form a virtual 3-D map of the environment of the UAV, the 3-D map generated by projecting voxels onto corresponding points on an RGB image generated by the RGB camera, wherein the voxels represent physical objects detected by the UAV.

18. The UAV of claim 16, wherein the environment data is used by the processor avoid obstacles in a flight path by sending control signals to the flight controller.

19. The UAV of claim 16, wherein collision recovery is performed by detecting and compensating for a sudden acceleration or deceleration using control signals transmitted to the flight controller.

20. The UAV of claim 11, wherein the visual camera is aimed to the side of the UAV to capture visual data from the side of the UAV.

21. A system for generating a 3-D map of an environment, the system comprising:
an unmanned aerial vehicle (UAV) configured to navigate a flight environment autonomously by collecting flight data to perform obstacle avoidance and/or collision recovery;
a base station for wirelessly collecting the flight data to generate environment data, the environment data including flight data from one or more UAVs; and
a computing resource for receiving the environment data to form a virtual 3-D map of the environment of the UAV, the 3-D map generated by projecting voxels onto corresponding points on an RGB image, and wherein the voxels represent physical objects detected by the UAV.

22. The system of claim 21, wherein the computing resource includes a cloud-based data storage service used to store the environmental data in a database.

23. The system of claim 21, wherein the computing resource includes a cloud-based processor service used to analyze the environment data to form the virtual 3-D map.

24. The system of claim 21, wherein the flight data includes high resolution images of the flight environment, wherein the high-resolution images are analyzed to recognize objects for operational monitoring or management.

25. The system of claim 24, wherein the objects are units of goods or barcodes associated with the units of goods, and the analysis is performed to monitor the inventory status of the goods.

26. The system of claim 24, wherein the objects are automated equipment, and the analysis is performed to monitor operation of the automated equipment.

27. The system of claim 21, further comprising a docking station for providing power to the UAV.
